(19) United States
(12) Patent Application Publication
(10) Pub. No.: US 2015/0093479 A1
(43) Pub. Date: Apr. 2, 2015

(54) Birch Sap Beverage

(71) Applicant: Feronia Forests, LLC, New York, NY (US)

(72) Inventors: Paolo Cugnasca, New York, NY (US); Michael L. Farrell, Lake Placid, NY (US)

(73) Assignee: Feronia Forests, LLC

(21) Appl. No.: 14/557,775

(22) Filed: Dec. 2, 2014

Related U.S. Application Data
(62) Division of application No. 13/690,420, filed on Nov. 30, 2012.

(51) Int. Cl. A23L 2/38; A23L 2/60; A23L 2/46; A23L 2/72; A23L 2/74; A23L 2/56; A23L 2/50

(52) U.S. Cl. CPC A23L 2/38; A23L 2/56; A23L 2/60; A23L 2/50; A23L 2/72; A23L 2/74; A23L 2/46; A23V 2002/00
USPC 426/248; 426/590; 426/392

(57) ABSTRACT

A birch sap beverage having an extended shelf life and process for the manufacture thereof in which a birch sap is adjusted to a standard pre-determined Brix value and then subjected to either (a) ultra-high temperature (UHT) pasteurization followed with aseptic packaging (b) packaging followed by UHT. Additional birch sap products having extended shelf life are also disclosed and claimed.

### CROSS-REFERENCE TO RELATED APPLICATIONS

Not Applicable.

### STATEMENT REGARDING FEDERALLY SPONSORED RESEARCH OR DEVELOPMENT

Not Applicable

### FIELD OF THE INVENTION

The present invention relates to birch sap, birch sap products, and particularly to beverages made from birch sap (but not including “permeate” (defined below) or essentially pure water even though derived from a birch sap). The invention further relates to natural ingestible products, especially beverages derived from birch sap. The present invention further relates to the use of ultra-high temperature pasteurization (UHT) in connection with assuring an adequate shelf life for a birch sap beverage or birch sap product through aseptic packaging or using UHT as a terminal sterilization with or without (preferably with) aseptic packaging.

### BACKGROUND OF THE INVENTION

Birch sap is a naturally occurring, unprocessed crystal-clear liquid, having the consistency and clarity of water, which derives from birch trees (Betula spp). It is generally available from the birch trees during the early spring in the 2-3 weeks before the leaves open. Paper birch (Betula papyrifera), yellow birch (Betula alleghaniensis), and black birch (Betula lenta) are the preferred species for sap collection though any species of birch is suitable. Birch sap has a sugar content anywhere from approximately 0.1° to 2.5° Brix, the majority of the sugar content being glucose and fructose. The remainder of the birch sap content is naturally occurring water, electrolytes, and very small amounts of organic acids. Birch sap (whether or not concentrated or diluted) is not to be confused with “birch syrup” which is the viscous liquid obtained by both concentration and heat treatment (generally boiling) of birch sap. Because birch sap is only available during a short season, products made therefrom are either available only during a short selling period or need to be processed in a manner which will give it sufficient shelf life to last from one production year to another. One manner of giving natural perishable products a longer shelf life than would otherwise be the case is pasteurization. Unfortunately, typical pasteurization still does not give the products such as birch sap an adequate shelf life.

Some people are familiar with birch syrup, it is similar to maple syrup but has a much different flavor. Birch syrup is distinct from and vastly different than maple syrup, although both maple syrup and birch syrup are derived from the sap of the respective species. Birch sap usually has a typical Brix value of 0.4° to 1° Brix, though it can be as low as 0.1 Brix and as high as 2.5 Brix. (The degrees Brix is a scale that is used for measuring the density of sugar in solution. The “degrees Brix” (° Brix) means that the solution under consideration has the same density as a solution containing a percentage of sugar numerically equal to the Brix value.)

In the production of birch syrup from birch sap, the birch sap is collected and subjected to an initial filtration. It is collected for storage for further processing and may be subjected to an ultraviolet (UV) irradiation to control bacterial load during the pre-processing storage. The collected sap often has water removed, generally by a reverse osmosis process to obtain a “concentrated birch sap” or “concentrate”. The removed water (generally referred to as “permeate”, when the water removal process used is reverse osmosis) is usually treated as a waste product. The permeate, which may also be referred to as “birch water” (not of the present invention), is essentially pure water that is just derived from birch sap.

US 20110081455, US 20090104312, US 20080226797, US 20080226798 and U.S. Pat. No. 8,029,846 briefly discuss UHT in connection with non-birch products. US 201100023728 is a patent directed to specialty pasteurization equipment. U.S. Pat. No. 7,906,160 is directed to protein beverages and refers to sterilization without the use of thermal processing. U.S. Pat. No. 7,897,192 is directed to carbonated protein beverages and mentions ordinary pasteurization (140° F. to 188° F. for 10 seconds to about 60 seconds). Other family members of U.S. Pat. No. 7,906,160 and U.S. Pat. No. 7,897,192 are directed to protein beverages and some claims do and some claims do not mention the avoidance of thermal processing. U.S. Pat. No. 7,799,363 is one of those family members and mentions an alternate sterilization process high pressure processing (HPP) in claim 22 of that document in connection with such protein beverages.

US 20100178400 is directed to a whole grain beverage and the use of 275° to 305° F. for about 2-3 seconds (see claim 13 thereof).

### OBJECTS OF THE INVENTION

An object of the invention is to provide a birch sap product having a shelf life of at least 6 months post bottling.

Another object of the invention is to provide a birch sap product having a shelf life post bottling of at least 1 year.

A further object of the invention is to provide a birch sap product in the form of a beverage with a sufficiently long shelf life that product may be sold and consumed across an entire year from a single season's birch sap harvesting.

Yet another object of the invention is to provide a method of obtaining a birch sap product free of chemical preservatives that has a shelf life of at least 6 months.

a still further object of the invention is to provide a birch sap beverage that is a “natural” product and has a shelf life of at least 6 months.

Still other objects of the invention will be recognized by those of ordinary skill in the art.

### BRIEF SUMMARY OF THE INVENTION

These and other objects of the invention are surprisingly achieved by (a) obtaining a birch sap, (b) optionally adjusting the Brix value to a preselected value in the range of 0.1° Brix to 15° Brix to obtain a Brix adjusted sap, (c) subjecting the birch sap (or Brix adjusted sap) ultra-high temperature pasteurization (UHT) to obtain a sterilized sap product, and (d) packaging the sterilized sap product in an aseptic manner. If the packaging is conducted prior to the UHT, the packaging need not necessarily be done aseptically, but preferably is done aseptically so as to reduce the potential bio-load that the sterilization procedure must deal with.

### BRIEF DESCRIPTION OF THE DRAWING

Not Applicable

### DETAILED DESCRIPTION OF THE INVENTION

The present invention is directed to a birch sap product, especially to a birch sap beverage, wherein the birch sap beverage contains only birch sap, optionally additional water, and optionally additional flavorings (preferably natural flavorings). While the birch sap beverage or birch sap product of the invention can further contain artificial ingredients (such as artificial flavorings, artificial sweeteners, and preservatives) and natural sweeteners obtained from other sources than birch sap, the birch sap beverage of the invention and other birch sap products of the invention are substantially free of and more preferably completely free of any artificial ingredients and most preferably consist of only materials obtained from birch sap and optionally additional natural flavorings. Thus, in the most preferred embodiment of the invention, the invention contains only birch sap, optionally additional water (most preferably permeate from birch sap), optional natural flavorings, and no sweeteners obtained from non-birch sources.

Throughout this specification, where a numerical value is indicated with the modifier “about”, the same numerical term without the modifier “about” is deemed disclosed as well. Where ranges are indicated, specific values between the values explicitly disclosed are deemed disclosed as well as if they had been specifically disclosed. Where limits are described in a Markush Group as in “a lower limit selected from . . . ” intermediary values between the explicitly recited values are deemed to have been disclosed as if they were explicitly recited therein. Where numerical limitations have been set forth with alternate units with one or more being recited within parentheses after the primary number recitation, the alternate in the parentheses may be rounded to the last digit explicitly shown, but is deemed to include a specific recitation of the exact conversion of the unit recited before the corresponding parentheses the same as if such exact unit conversion had been explicitly recited. All patent and patent applications mentioned in this specification are hereby incorporated by reference to the extent, that they supplement the present specification; however such incorporation shall not be construed to contradict statements explicitly made in this specification, and statements in two or more such patents or patent applications that are contradictory to each other shall simply not be considered as incorporated herein absent a specific incorporation herein of the particular passage of one or more of such documents.

A birch sap is obtained from a birch tree in early spring in the same manner as sap is obtained for the production of birch syrup. On collection it is generally filtered to remove gross impurities such as twigs, bark, soil, insect parts, etc. generally using serial filtering with (usually up to three or more) filters sequentially of finer pore size using filters in the range of 1-100 micron pore size, preferably in the range of 1-10 microns pore size (the exact pore size being any that is convenient for use to remove the gross contaminants), and is usually (but optionally) subjected to a partial sterilization procedure such as (a) exposure to ultraviolet (UV)-irradiation, (b) standard pasteurization (under 100° C.) or (c) micro- and/or nano-filtration; however, it is preferable in the practice of the present invention that any partial sterilization at this point be a non-heat-treatment one; with UV-irradiation being preferred. The partial sterilization process step at this point is to, allow the collected sap to be stored for a short period of time (up to a few days) before further processing. The collected and optionally stored birch sap is then adjusted to a pre-determined Brix value (if needed) where the pre-determined Brix value is selected from a value of 0.1° Brix to a value of 15° Brix by (i) removing water therefrom if the Brix value is lower than desired and (ii) adding water if the Brix value is higher than desired, and frequently both are used to obtain the specific product Brix value desired. Preferably the water is selected from (a) drinking water, (b) distilled water, (c) de-ionized water, (d) sterile water, (e) a birch water (i.e. water derived from a birch tree, typically a permeate obtained from a birch sap in the course of processing such birch sap into syrup) or mixtures thereof, more preferably, the water is a birch water. Alternatively, if appropriate Brix value birch saps are at hand, some above the desired Brix value and some below the desired Brix value they can be blended in appropriate proportions to arrive at a birch sap of the desired Brix value without departing from the invention. The birch water used may be (i) derived from an earlier stage of the birch sap then being processed or (ii) from another batch of birch sap that has been (a) processed according to the invention or (b) processed in order to make another birch product such as birch syrup.

Although the Brix value of the product of the invention in question may vary from 0.1 to 15, for a beverage product, it is more typically in the range of a lower limit selected from 0.1 to about 6, still more preferably from about 0.2, about 0.3, about 0.4, about 0.5, about 0.6, about 0.7, about 0.8, about 0.9, about 1.0, about 1.2, about 1.4, about 1.5, about 1.6, about 1.8, and about 2.0 to an upper limit selected from about 6, about 5.5, about 5.0, about 4.5, about 4.0, about 3.5, about 3.0, about 2.8, about 2.6, about 2.5, about 2.4, about 2.2, and about 2.0. More highly preferred ranges for a beverage product have a lower end of the range selected from about 0.3, about 0.4, and about 0.5 to an upper end of the range selected from about 0.8, about 0.9, and about 1.0, and a most highly preferred beverage Brix value is about 0.5. In addition to the specifically recited endpoints of the various ranges specifically recited, the invention further includes each intermediary lower endpoint and each intermediary upper end point between those specifically stated as if each had been explicitly recited herein.

For non-beverage products, such as those used for cooking and flavoring other products (non-beverage products of the invention), the full range of the 0.1° to 15° Brix is completely suitable, but more preferably the pre-determined Brix value lower end of the range is selected from about 4, about 5, about 6, about 7, about 8, about 9, about 10 and the upper end of the range of the pre-determined Brix value is selected from about 15, about 14, about 13, about 12, about 11, and about 10. In addition to the specifically recited endpoints of the various ranges specifically recited for the non-beverage products of the invention, the invention further includes each intermediary lower endpoint and each intermediary upper end point between those specifically stated as if each had been explicitly recited herein.

Once the birch sap has the appropriate desired Brix value, it is subjected to ultra-high temperature pasteurization (UHT) and generally aseptic packaging as a means of ensuring the appropriate sterility and shelf life, although the aseptic packaging may be eliminated if the UHT is a terminal sterilization, but preferably, the aseptic packing is still used even if the UHT is a terminal sterilization. Aseptic packaging techniques and equipment for liquid products is generally known in the food and drug product fields and such techniques are fully acceptable for use in the present invention and are usually employed (as set forth hereinbelow). The desired post bottling shelf life for the product of the invention, whether a beverage or non-beverage product, is selected from at least 6 months, at least 7 months, at least 8 months, at least 9 months, at least 10 months, at least 11 months, at least 12 months, at least 13 months, at least 14 months, and at least 15 months post bottling. Of the above shelf lives, those of 9 months and longer are preferable, and those of a year or more are still more preferable. Most highly preferred shelf lives are those of at least 15 months as these allow for the most flexibility in maintaining the respective products in the chain of commerce continuously throughout the year with a reasonable time for consumption thereof until the product from the next harvest reaches the shelf.

The means for obtaining the required shelf life in the present invention is the use of ultra-high temperature pasteurization (UHT), and in the situation where the liquid product is being transferred to other packaging after the UHT such packaging is done aseptically. While it is possible to omit the aseptic packaging if such final packaging is done prior to the UHT step (i.e. using UHT as a terminal sterilization), it is preferred to still use aseptic packaging even here as a means to limit the bioburden that the terminal sterilization must deal with, and thus further assure adequate sterilization and shelf life. UHT processing of other products, such as milk and dairy products is known and it is further known that such processing of milk perceptibly changes the flavor and taste of milk so processed. It is also known that temperature processing of maple sap for the production of maple syrup by boiling (lower temperatures than in UHT, but for longer times) changes both the appearance and taste of the maple sap and that the same process changes the taste of birch sap when producing birch syrup. In addition, according to Kirk-Othmer, Encyclopedia of Chemical Technology, 5^{th} Edition 2006, Vol 18, pages 32-33 in discussing dairy products, states:
“In recent years, higher heat treatments, eg, ultrahigh temperature (UHT)-short time has been applied in conjunction with clean filling of treated polyester bottles to produce extended shelf life (ESL) packaged products capable of up to 90 days of refrigerated shelf life.
In aseptic packaging, milk is sterilized, eg rendered free of microorganisms usually by UHT technologies. Simultaneously, high barrier paperboard-foil-plastic lamination or all plastic packaging material is sterilized often by hydrogen peroxide. The two are assembled in a sterile environment and package is sealed to produce sterile milk in a sterile package. The increased heat required for sterilization of the milk can lead to flavors different from those in pasteurized refrigerated milk. Aseptically packaged milk may be distributed at ambient temperature.”
   Thus, for a beverage product that is intended to be as close to a natural sap as possible, ultra-high temperature processing would not appear to be a logical method to select for sterilization purposes, and in the absence of post UHT “aseptic packaging” and absence of UHT as a terminal sterilization step even the 90 day shelf life indicated would not be sufficiently suitable for the currently desired product. Nonetheless, surprisingly, it has been found that such UHT processing with aseptic packaging or UHT as a terminal sterilization (with or without the aseptic packaging, but preferably with it) delivers both the desired sterility and much more extended shelf life and does not perceptibly alter the consistency, the look, or the taste of the birch sap so processed. For the present invention, UHT means subjecting the product to a temperature of at least 130° C., preferably at least 135° C. , more preferably at least 137° C. for a time period of about 1 to about 10 seconds, preferably about 2 to about 6 seconds, more preferably about 2 to about 4 seconds. In addition, for the purposes of the present invention, the UHT temperature should not exceed about 150° C., preferably not exceed 145° C., still more preferably not exceed 140° C., and most preferably not exceed 139° C.

For the present invention, at the time of bottling, the present invention products have a bacterial load of not more than 10 colony forming units/mL (cfu/mL), more preferably not more than 5, still more preferably not more than 4, even more preferably not more than 3, yet more preferably not more than 2, even still more preferably not more than 1, and most preferably zero cfu/mL. In addition, the products of the present invention when stored at 4° C. for a period selected from 6 months have a bacterial load of not more than 10 colony forming units/mL (cfu/mL), more preferably not more than 5, still more preferably not more than 4, even more preferably not more than 3, yet more preferably not more than 2, even still more preferably not more than 1, and most preferably zero cfu/mL, more preferably the bacterial load specified is present after storage for 7 months, still more preferably after 8 months, yet more preferably after 9 months, still more preferably after 10 months, even more preferably after 11 months, still even more preferably after 12 months, yet more preferably after 15 months, even more preferably after 18 months, still more preferably after 21 months, and most preferably after 24 months. In each of the above, the bacterial load limitation is met when measured on the day that the storage time specified is first met and a measure even as much as a day later should not be construed as not meeting the definition if it has been met on the particular day indicated. Thus, where the limitation is not more than 10 cfu/mL after storage for 6 months is met when a product has 10 a bacterial load of 10 cfu/mL on the 6 month anniversary of bottling when stored at the recited condition, and no change in the bacterial load thereafter to greater than 10 cfu/ml (even if measured on 6 months and 1 day after bottling, even though the longer storage limitation (such as not more than 10 cfu/mL at 7 months from bottling) would not be met. It should also be noted that the above recited storage conditions are merely present as a means to have a specific test for measuring the product shelf life and is not a limitation on the product (i.e. the product is not required to be stored at the stated conditions, except for testing a representative sample to determine if a product falls within the claims that require a shelf life limitation).

Still further, the products of the present invention when stored at ambient temperature (21° C. to 25° C.) for a period selected from 6 months have a bacterial load of not more than 10 colony forming units/mL (cfu/mL), more preferably not more than 5, still more preferably not more than 4, even more preferably not more than 3, yet more preferably not more than 2, even still more preferably not more than 1, and most preferably zero cfu/mL, more preferably the bacterial load specified is present after storage for 7 months, still more preferably after 8 months, yet more preferably after 9 months, still more preferably after 10 months, even more preferably after 11 months, still even more preferably after 12 months, yet more preferably after 15 months, even more preferably after 8 months, still more preferably after 21 months, and most preferably after 24 months. In each of the above, the bacterial load limitation is met when measured on the day that the storage time specified is first met and a measure even as much as a day later should not be construed as not meeting the definition if it has been met on, the particular day indicated. Thus, where the limitation is not more than 10 cfu/mL after storage for 6 months is met when a product has 10 a bacterial load of 10 cfu/mL on the 6 month anniversary of bottling when stored at the recited condition, and no change in the bacterial load thereafter to greater than 10 cfu/ml (even if measured on 6 months and 1 day after bottling, even though the longer storage limitation (such as not more than 10 cfu/mL at 7 months from bottling) would not be met. It should also be noted that the above recited storage conditions are merely present as a means to have a specific test for measuring the product shelf life and is not a limitation on the product (i.e. the product is not required to be stored at the stated conditions, except for testing a representative sample to determine if a product falls within the claims that require a shelf life limitation). Also, it should be noted that this is an independent testing limitation from that at the 4° C. storage conditions in the preceding paragraph so that a product has the requisite storage shelf life if it meets either or both of this ambient temperature storage condition or the refrigerated (4° C.) storage condition of the preceding paragraph.

Optional preservatives, sweeteners, and flavors can be selected from any of those known in the art, whether natural or artificial. However, it is preferable to only include natural ingredients in the present invention (and further, of the sweeteners, to only include sweeteners that arise from a birch sap). With respect to flavorings, any flavoring known in the beverage art may be used, but again, preferably only natural flavorings are desired. Included, without limitation, as suitable flavorings for the instant invention are: apple, apricot, banana, Barbados cherry (acerola cherry), blackberry, blueberry, boysenberry, buckthorn, cardamom, cassia, cassis, cherry, choke cherry, cinnamon, coconut, clove, coffee, cola, coriander, cranberry, currant, date, dewberry, elderberry, fig, ginger, ginseng, gooseberry, grape, grapefruit, guava, huckleberry, kiwi, lemon, lime, litchi, loganberry, mandarin Orange, mango, mulberry, olive, orange, papaya, passion fruit, peach, pear, pepper, persimmon, pineapple, plains berry, plum, pomegranate, pomelo, prairie berry, prune, quince, raspberry, rhubarb, root beer, rowan, saskatoon berry, sassafras, sloe, strawberry, tangerine, tangelo, tea, tomato, vanilla, and yerba mate.

### EXAMPLES

The following examples exemplify, but do not limit, the present invention.

### Example 1

A birch sap beverage product of the invention is prepared as set forth below:

A birch sap is obtained and filtered to removed gross impurities and subjected to UV-irradiation to partially sterilize the sap. The Brix value is measured and adjusted with reverse osmosis and addition of a birch water as needed to achieve a Brix value of about 0.5° Brix. The product is subjected to UHT at 135° C. for about 6 seconds and bottled in an aseptic package under aseptic conditions.

### Example 2

A birch sap non-beverage product of the invention is prepared as set forth below:

A birch sap is obtained and filtered to removed gross impurities and subjected to UV-irradiation to partially sterilize the sap. The Brix value is measured and adjusted with reverse osmosis to achieve a Brix value of about 12.0° Brix. The product is subjected to UHT at 135° C. for about 6 seconds and bottled in an aseptic package under aseptic conditions.

### Example 3

A birch sap beverage product of the invention is prepared as set forth below:

A first birch sap is obtained and filtered to removed gross impurities and subjected to UV-irradiation to partially sterilize the sap. The Brix value is measured and found to be 0.8° Brix (in excess of the desired 0.6° Brix for a particular product). A second birch sap is obtained and filtered to remove gross impurities and subjected to UV-irradiation to partially sterilize the sap. The Brix value of the second birch sap is measured and found to be in 0.4° Brix (below that of the desired Brix value for a particular product). Blending 1 part by volume of the first birch Sap (0.8° Brix) and 1 part by volume of the second birch sap (0.4° Brix) yields 2 parts by volume of a blended birch sap having the desired 0.6° Brix value. The product is subjected to UHT at 135° C. for about 6 seconds and bottled in an aseptic package under aseptic conditions.

### Example 4

The products of Examples 1-3 are prepared except that after adjustment of the Brix value, the products, are packaged aseptically before the UHT step and then subjected to UHT as a terminal sterilization step.

### Example 5

The products of Examples 1-3 are prepared except that after adjustment of the Brix value, the products are packaged non-aseptically before the UHT step and then subjected to UHT as a terminal sterilization step.

1. (canceled)

2. The method of claim 16 wherein the Brix value of said first birch sap is adjusted to form said second birch sap, and if the water is used to add (added water) to said first birch sap in order to adjust said Brix value of said first birch sap, said added water is selected from (a) drinking water, (b) distilled water; (c) de-ionized water; (d) sterile water; and (e) birch water derived from birch tree sap.

3. The method of claim 2 wherein the birch water of claim 2(e) is derived from
(a) a reverse osmosis process from
(i) said first birch sap or
(ii) a second birch sap or
(b) a process of converting said second birch sap into
(i) a concentrated birch sap or
(ii) a birch syrup; or
(c) converting concentrated birch sap into birch syrup; or
(d) converting any of said second birch sap, said concentrated birch sap, and said birch syrup into another birch product.

4. (canceled)

5. The method of claim 16 having a micro-organism load at the time of being packaged by said aseptic packaging after said Ultra-High Temperature pasteurization of not more that 0 CFU/ml.

6. (canceled)

7. The method of claim 16 having a micro-organism load after being packaged by said aseptic packaging and being subjected to said Ultra-High Temperature pasteurization and having been stored at 4° C. for a period of 24 months of not more than 10 CFU/ml.

8. The method of claim 16 having a micro-organism load after being packaged by said aseptic packaging and being subjected to said Ultra-High Temperature pasteurization and having been stored at ambient temperature of from about 20 to about 25° C. for a period of 9 months of not more than 0 CFU/ml.

9. The method of claim 8 having a micro-organism load after being packaged by said aseptic packaging and being subjected to said Ultra-High Temperature pasteurization and haying been stored at 21° C. for a period of 24 months of not more than 0 CFU/ml.

10. The method of claim 16 having a shelf life of at least 6 months after being packaged by said aseptic packaging and subjected to said Ultra-High Temperature pasteurization.

11. The method of claim 16 having a shelf life of at least 24 months after being packaged by said aseptic packaging and subjected to said Ultra-High Temperature pasteurization.

12. The method of claim 16 wherein the second birch sap has a Brix value of 1.4 to 2.2.

13. The method of claim 16 wherein the Ultra-High Temperature pasteurization is conducted at a temperature of at least 135° C. up to 145° C. for a period of from 2 to 6 seconds.

14. The method of claim 16 wherein the Ultra-High Temperature pasteurization is conducted at a temperature of at least 135° C. up to 140° C. for a period of from 1 to 10 seconds.

15. The method of claim 14 wherein the Ultra-High Temperature is conducted at a temperature of at least 137° C. up to 139° C. for a period of from 2 to 4 seconds.

16. A method of making a birch sap beverage product having a Brix value of about 0.1 to about 15 comprising a first birch sap comprising water,
said first birch sap having a sap Brix value in the range of about 0.1 to about 2.5; or a second birch sap comprising water wherein said second birch sap is said first birch sap which has had its Brix value adjusted to have a predefined Brix value in the range of from about 0.1 to about 15.0, and upon having been subjected to an Ultra-High Temperature pasteurization (UHT) and packaging under aseptic conditions, at the time of said packaging and said UHT, said birch sap product having a micro-organism load of not more than 10 colony forming units/ml (CFU/ml) and after 9 months of storage at 4° C. a micro-organism load of not more than 10 CFU/ml;
said method consisting essentially of
A) obtaining said first birch sap;
B) optionally filtering the first birch sap in one or more filtration steps;
C) optionally exposing the first birch sap to a first partial sterilization process selected from
(i) ultraviolet (UV) sterilization,
(ii) low temperature pasteurization, and
(iii) one or more of micro and nano filtration;
(D) optionally adjusting said first birch sap to a predefined Brix value in the range of about 0.1 to about 15 defining a second birch sap;
(E) optionally adding one or more additional flavorings;
(F) optionally adding or one or more additional sweeteners;
the results of said step A) and optionally any of said optional steps B) through F) resulting in a pre-UHT, prior to being packaged product; and
(G) subjecting said pre-UHT, prior to being packaged product to either of
(a) said Ultra-High Temperature pasteurization step followed by said packaging under aspetic conditions; or
(b) using said septic conditions to package said pre-UHT, prior to being packaged product followed by using said UHT as a terminal sterilization step;
wherein said optional step D) and optional step E) and optical step F) can each independently be done at any point after obtaining said first birch sap until after said step G), provided that if one or more of steps D), E) and F) are performed after step G), that the respective materials used therein and the conditions of carrying out such steps carried out after step G) be aseptic and conducted under aseptic conditions
whereby said birch beverage product at the time of packaging but after said UHT having a micro-organism load of not more than 10 CFU/ml and after 9 months of storage at 4° C. a micro-organism load of not more than 10 CFU/ml.

17. The method of claim 16 consisting essentially of
A) obtaining said first birch sap;
B) filtering said first birch sap in one or more filtration steps to yield a filtered first birch sap;
C) exposing said filtered first birch sap to an ultraviolet (UV) sterilization to yield a UV exposed birch sap;
D) optionally adjusting said UV exposed birch sap to said predefined Brix value;
E) optionally adding one or more additional flavorings;
F) optionally adding one or more additional sweeteners;
the result of steps A)-C) and any additional steps D) through F) resulting in a pre-UHT, prior to being packaged product;
G) subjecting the pre-UHT, prior to being packaged product to an Ultra-High Temperature pasteurization step to result in a final product; and
H) packaging the final product in an aspetic package under aseptic conditions;
wherein said optional step D), optional step E), and optional step F) can each independently be done at any point after obtaining the first birch sap until after said step G), provided that if one or more of said optional steps D), E), and F) are performed after step G), that the respective materials used therein and the conditions of carrying out such steps carried out after step G) be aseptic and conducted under aseptic conditions.

18. The method of claim 16 wherein said filtering in step B) is conducted in 1 or more steps and includes at least one filter in the range of 1 micron to 10 micron pore size.

19. The method of claim 16 wherein said UHT is conducted at a temperature of about 130° C. to about 150° C.

20. The method of claim 19 wherein said UHT is conducted at a temperature of about 135° C. to about 145° C.

21. The method of claim 16 wherein said UHT is conducted for a period of about 1 second to about 10 seconds.

22. The method of claim 21 wherein said UHT is conducted for a period of about 2 seconds to about 6 seconds.

23. A method of making a cooking and/or flavoring birch sap product having a product Brix value in the range of about 0.1 to about 15.0 for use in cooking, and/or flavoring of other products, comprising a first birch sap comprising water,
said first birch sap having a sap Brix value in the range of about 0.1 to about 2.5; or a second birch sap comprising water wherein said second birch sap is said first birch sap which has had its Brix value adjusted to have a predefined Brix value in the range of from about 0.1 to about 15.0, and upon having been subjected to an Ultra-High Temperature pasteurization (UHT) and packaging under aseptic conditions, at the time of said packaging and said UHT, said birch sap product having a micro-organism load of not more than 10 colony forming units/ml (CFU/ml) and after 9 months of storage at 4° C. a micro-organism load of not more than 10 CFU/ml;
said method consisting essentially of
A) obtaining said first birch sap;
B) optionally filtering, the first birch sap in one or more filtration steps;
C) optionally exposing the sap to said first partial sterilization process selected from
(i) said ultraviolet (UV) sterilization,
(ii) low temperature pasteurization, and
(iii) one or more of micro and nano filtration;
D) optionally adjusting said first birch sap to said pre-defined Brix value;
E) optionally adding one or more of additional flavorings;
F) optionally adding one or more of additional sweeteners;
the results of said step A) and optionally any of said optional steps B) through F) resulting, in said pre-UHT, prior to being packaged product; and
G) subjecting the pre-UHT, prior to being packaged product to either of
(a) an Ultra-High Temperature pasteurization (UHT) step followed by aseptic packaging; or
(b) using aseptic conditions to package said pre-UHT, prior to being packaged product followed by using UHT as a terminal sterilization step;
wherein said optional step D), said optional step E) and said optional step F) can each independently be done at any point after obtaining, the sap until after said step G), provided that if one or more of steps D), E) and F) are performed after step G), that the respective materials used therein and the conditions of carrying out such steps carried out after step G) be aseptic and conducted under aseptic conditions
whereby said birch sap product at the time of packaging, but after said UHT having a micro-organism load of not more than 10 colony forming units/ml and after 9 months of storage at 4° C. a micro-organism load of not more than 10 colony forming units/ml.

24. A method of cooking and/or flavoring other products comprising utilizing the birch sap product resulting from claim 23 in a step of cooking or flavoring said other products.

25. The process of claim 16 resulting in a product having a micro-organism load after being packaged by said aseptic packaging and being subjected to said Ultra-High Temperature pasteurization and having been stored at 4° C. for a period of 9 months of not more than 5 CFU/ml.

26. The process of claim 15 having a micro-organism load after being packaged by said aseptic packaging and being subjected to said Ultra-High Temperature pasteurization and having been stored at 4° C. for a period of 6 months of not more than 3 CFU/ml.

27. The process of claim 23 resulting in a product having a micro-organism load after being packaged by said aseptic packaging and being subjected to said Ultra-High Temperature pasteurization and having, been stored at 4° C. for a period of 9 months of not more than 5 CFU/ml.

28. The process of claim 23 having a microorganism road after being packaged by said aseptic packaging and being subjected to said Ultra-High Temperature pasteurization and having been stored at 4° C. for a period of 6 months of not more than 3 CFU/ml.
